(19) United States
(12) Patent Application Publication
(10) Pub. No.: US 2024/0212678 A1
(43) Pub. Date: Jun. 27, 2024

(54) MULTI-PARTICIPANT VOICE ORDERING

(71) Applicant: SoundHound AI IP, LLC, Santa Clara, CA (US)

(72) Inventors: Robert Macrae, Mountain View, CA (US); Jon Grossman, Cupertino, CA (US); Scott Halstvedt, Santa Clara, CA (US)

(73) Assignee: SoundHound AI IP, LLC, Santa Clara, CA (US)

(21) Appl. No.: 18/391,886

(22) Filed: Dec. 21, 2023

Related U.S. Application Data
(60) Provisional application No. 63/476,928, filed on Dec. 22, 2022.

(51) Int. Cl. G10L 15/22; G06F 3/16; G06Q 50/12; G10L 15/02

(52) U.S. Cl. CPC G10L 15/22; G06F 3/167; G06Q 50/12; G10L 15/02; G10L 2015/223

(57) ABSTRACT

A voice interface recognizes spoken utterances from multiple users. It responds to the utterances in ways such as modifying the attributes of instances of items. The voice interface computes a voice vector for each utterance and associates it with the item instance that is modified. For following utterances with a closely matching voice vector, the voice interface modifies the same instance. For following utterances with a voice vector that is not a close match to one stored for any item instance, the voice interface modifies a different item instance.

### PRIORITY CLAIM

This application claims the benefit of U.S. Provisional Patent Application No. 63/476,928 filed on Dec. 22, 2022, which application is incorporated herein by reference.

### BACKGROUND

Computerized voice recognition systems are presently used in a various situations, with limited success, where voice input is received from multiple users. An example is using voice recognition systems to take food orders. One difficulty is distinguishing between different speakers. A second difficulty is recognizing the speech of the multiple users. Given these difficulties, voice recognition systems are not yet successfully used in these scenarios.

### SUMMARY

The following specification describes systems and methods that recognize spoken utterances from multiple speakers and distinguishes between the speakers by their voices. Such systems can then modify one of multiple items of the same type where the item modified corresponds to which user is identified.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### DESCRIPTION OF THE DRAWINGS

FIG. 1 shows segmentation of audio into request utterances.

FIG. 2 shows processing utterances to calculate voice vectors and recognize spoken requests.

FIG. 3 shows a fast food order data structure changing with a sequence of utterances.

FIG. 4 shows a flowchart for a process of modifying one or another instance of a type of item based on voice.

FIG. 5 shows users ordering by voice at a fast food kiosk.

FIG. 6A shows a Flash RAM chip.

FIG. 6B shows a system-on-chip.

FIG. 6C shows a functional diagram of the system-on-chip.

### DETAILED DESCRIPTION

Various devices, systems of networked devices, API-controlled cloud services, and other things that present computerized voice interfaces are able to receive audio, detect that the audio includes a voice speaking, infer a transcription of the speech, and understand the transcription as a query or command. Such voice interfaces can then act on the understood queries or commands by performing an action, retrieving information, or determining that it is impossible to do so, and then respond accordingly in the form of information that might be useful to a user.

Some voice interfaces receive audio directly from a microphone or from a digital sampling of the air pressure waves that actuate the microphone. Some voice interfaces receive digital audio from a remote device either as direct digital samples, frames of frequency domain transformations of such sampled digital signals, or compressed representations of such. Examples of formats of audio representations are WAV, MP3, and Speex.

Voice interfaces of devices such as mobile phones, output information directly on a display screen, through a speaker using synthesized speech, through a haptic vibrator, or using other actuator functions of the phone. Some voice interfaces, such as an API hosted by a cloud server, output information as response messages corresponding to request messages. The output information can include things such as text or spoken answers to questions, confirmation that an action or other invoked function has been initiated or completed, or the status of the interface, device, system, server, or data stored on any of those.

One example is a voice interface for ordering food from a restaurant. Such an interface operates in sessions that end with a payment and begin with the following user interaction. In some cases, a user interaction begins when the interface detects that a person has spoken a specific wake phrase or senses that a person has manually interacted with a device. In some cases, the voice interface continuously performs speech recognition and, for words recognized with sufficiently high confidence, matches the words to patterns that correspond to understandings of the intention of the person speaking the words.

To infer an understanding of words spoken in a continuous sequence of audio, it is necessary to segment the audio. This can be done several ways. One way is to run a voice activity detection function on the audio and determine the start of segments as when voice activity is detected until the time that voice activity is not detected if no further voice activity is detected for a specific period of time.

Another way to segment audio is to recognize semantically complete sequences of words. This can be done by comparing the sequence of most recent words in a buffer to patterns. It's possible to handle cases in which a semantically complete pattern is a prefix to another pattern, by implementing a delay, in a range of about 1 to 10 seconds, after a match and discarding the match if a match to a longer pattern occurs within the delay period.

To avoid erroneously matching a pattern if the end of an earlier sequence and the start of an unrelated later sequence would match a pattern, it is possible to reset the word sequence after a period of time such as 5 to 30 seconds in which no new words are added to the buffer. Accordingly, items are only modified by commands if they are received within a period of time less than so many seconds.

For semantic segmentation, it can help to tag each word with approximately the wall clock time that it began being recognized from the input audio and/or the wall clock time that speech recognition finished with the word. The approximate time of the start of recognition of the first word in the semantically complete sequence of words is the start time of a segment. The approximate time of finishing recognizing the last word in the semantically complete sequence is the end time of the segment.

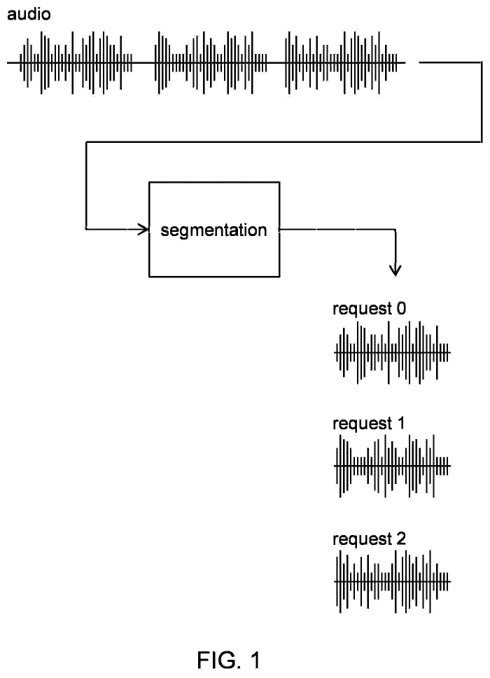

FIG. 1 shows a diagrammatic view of audio segmentation. A segmentation function runs on a stream of audio. This can occur continuously in real time, in increments, or offline for non-real-time analysis. The segmentation function computes start times and end times of segments in the stream of audio and outputs separate segments of audio. In FIG. 1, the segments of audio each contain a request to a voice interface.

### Voice Vectors

One way to implement multi-participant voice ordering is to discriminate between the voices by characterizing them numerically. Calculating a value for voices along a single dimension could enable discrimination based on gender but might not be sufficient to distinguish between people with similar sounding voices. A vector of multiple numbers that represent the sound of the voice along each of different dimensions provides greater accuracy in voice characterization and discrimination. It can even, in many cases, discriminate between the sounds of voices of identical twins.

Choosing the right dimensions improves accuracy. Choosing specific dimensions such as an estimate of gender, age, and even regional accents can work. But it can be even more accurate to use machine learning on a large data set with high diversity of voices to learn a multi-dimensional space using training that maximizes the dispersal of calculated voice vectors within the space.

With an appropriate multidimensional vector space, it is possible to characterize voices in speech audio as points represented by vectors. One approach to doing this is to calculate d-vectors on an ongoing basis per frame of audio or on relatively small numbers of samples. One approach to calculating d-vectors using deep neural networks (DNN) is described in the paper DEEP NEURAL NETWORKS FOR SMALL FOOTPRINT TEXT-DEPENDENT SPEAKER VERIFICATION by Ehsan Variani, Xin Lei, Erik McDermott, Ignacio Lopez Moreno, and Javier Gonzalez-Dominguez.

One way to calculate a voice vector for an entire segment is to aggregate the d-vectors calculated for each frame of audio from the start time to the finish time of the segment. Aggregation can be done in various ways such as computing an average across frames on a per-dimension basis. It can also be helpful in some cases to exclude d-vectors computed for frames with dispersal of energy across the spectrum such as is common during pronunciation of the phonemes ‘s’ and ‘sh’. D-vectors calculated on such frames can sometimes add noise that reduces the accuracy of an aggregate voice vector calculation. A continuous per-frame approach to calculating voice vectors during segments has the benefit of a relatively constant demand for CPU cycles, regardless of how long a segment of speech takes.

Another way to calculate a voice vector for an entire segment is to, upon detecting the finish of a segment, compute an x-vector for the entire segmented utterance. One approach to calculating x-vectors using DNNs is described in the paper X-VECTORS: ROBUST DNN EMBEDDINGS FOR SPEAKER RECOGNITION by David Snyder, Daniel Garcia-Romero, Gregory Sell, Daniel Povey, and Sanjeev Khudanpur. It's possible to compute x-vectors once for each segment after it is fully recognized. In some cases, it is more energy efficient to buffer audio while performing segmentation, then wake up a faster high-performance CPU for just a short amount of time to compute an x-vector for the full length of buffered audio data for the segment.

Calculating voice vectors can be used instead of or in addition to other segmentation functions. One approach would be to calculate a relatively short-term d-vector and a longer aggregated d-vector. They will be similar as long as the same voice is speaking. They will diverge when a change of voice occurs in the audio. A per-dimension sum of differences between the short-term and long-term average d-vector indicates a segment transition at the time or shortly before the beginning of a detectable divergence.

### Multiple Voices

For the purposes of multi-participant voice ordering, it can be helpful to segment speech, calculate voice vectors for the segments, then apply pattern matching or other forms of natural language understanding to act on voice requests. Then, actions in response to the voice requests can be made conditional on which of multiple voices made the request. For example, if items that are members of a list are associated with separate voices, requests for information or commands specific to items on the list can be performed specifically on the one or more item associated with the corresponding voice and not on other items.

Some voice interfaces do not know, in advance, how many people's voices will use the interface simultaneously. In some scenarios, it could be a single voice. In other scenarios it could be several voices. For such a voice interface, it can be helpful to be able to (a) discriminate between voices that have interacted with the interface during the session, and (b) infer that a segment of speech is by a voice that has not previously interacted with the interface during the session. In the latter situation, the interface can add the new voice vector to a list of voices known during the session.

One way to implement discrimination between recognized voices and inference of a new voice is to store, for each voice, an aggregate vector. It could be, for example, the aggregate of d-vectors computed over all frames of the most recent speech segment attributed to the voice. It could also be an aggregate across multiple segments attributed to the same voice.

A voice vector is then calculated for each new segment. If the new voice vector is within a threshold distance of any other known voice vector for the session, that voice is identified. If the new voice vector is within a threshold distance of a plurality of known voice vectors for the session, it is identified as the known voice closest to the newly calculated voice vector.

If the newly calculated voice vector is not within a threshold distance of any voice vector associated with a voice already in the session, then voice interface can infer that the segment is from a new voice and, in response, instantiate another voice, with the calculated voice vector, within the voices known for the session.

In some implementations of a voice interface, when a the voice vector calculated for a segment is within a threshold distance of more than one known voice vectors, instead of choosing the closest known voice vector as the correct one, if the understood request would have a different effect based on which of multiple voices said it, the voice interface can perform a disambiguation function such as by asking outputting a message requesting the user to try again or ask specifically which of the possible outcomes is correct. Such a message might be a request, “Did you mean the first one or the second one?” The interface would then store the request in memory and respond accordingly based on the next voice segment if the next voice segment clearly identifies either the first one or the second one.

Some implementations are able to handle multiple voices talking over each other. This can be done by classifying the recognized text as being one of three types. Text can be recognized and relevant, such as by matching a word pattern. Text can be recognized but irrelevant if speech recognition has a high confidence score, but the text of the segment does not match a pattern. Text can be uninterpretable if speech recognition over the segment fully or partly has a low confidence score.

Some voice interfaces, such as ones built into personal mobile devices or home smart speakers, have a known set of possible users. They are able to associate voices with specific user identities. Accordingly, the voice interface can address the users directly, even by name, in response to a match with their known voice vector. Such a voice interface can also store and access information such as the users' personal preferences and habits.

### Example Scenario

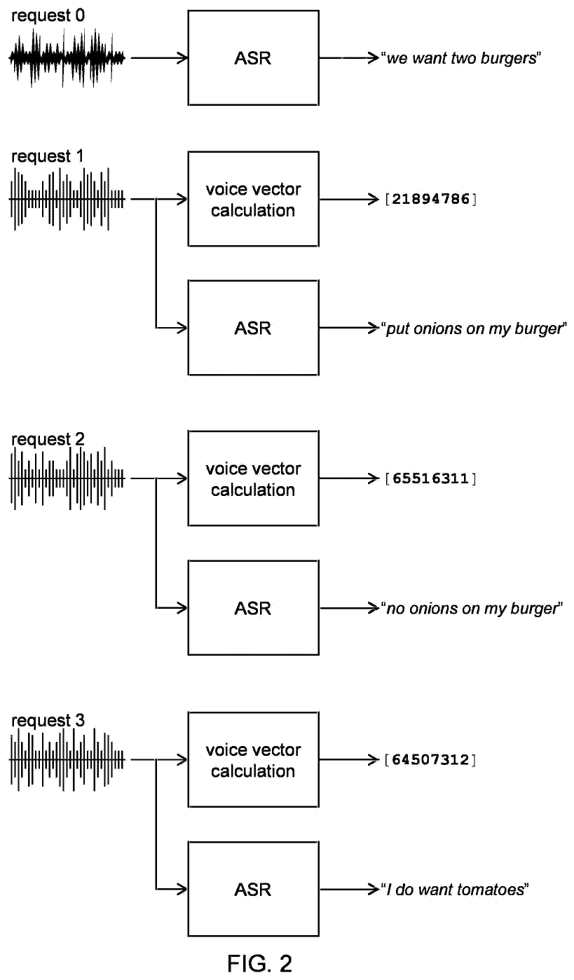

FIG. 2 shows a scenario, in 4 steps, in which two users each order a burger using a multi-participant voice ordering interface. As they speak, a segmentation function separates the audio into segments, each having a voice request. In request 0, somebody initiates a session by speaking the phrase “we want two burgers”. Automatic speech recognition (ASR) receives the audio and transcribes, from it, text with the spoken words. In some implementations, other functions besides ASR could be run on the audio.

With request 1, a voice vector calculation function runs on the audio and computes a voice vector 21894786. An ASR runs on the audio and transcribes the words “put onions on my burger”.

With request 2, a voice vector calculation function runs on the audio and computes a voice vector 65516311. An ASR runs on the audio and transcribes the words “no onions on my burger”.

With request 3, a voice vector calculation function runs on the audio and computes a voice vector 64507312. An ASR runs on the audio and transcribes the words “I do want tomatoes”.

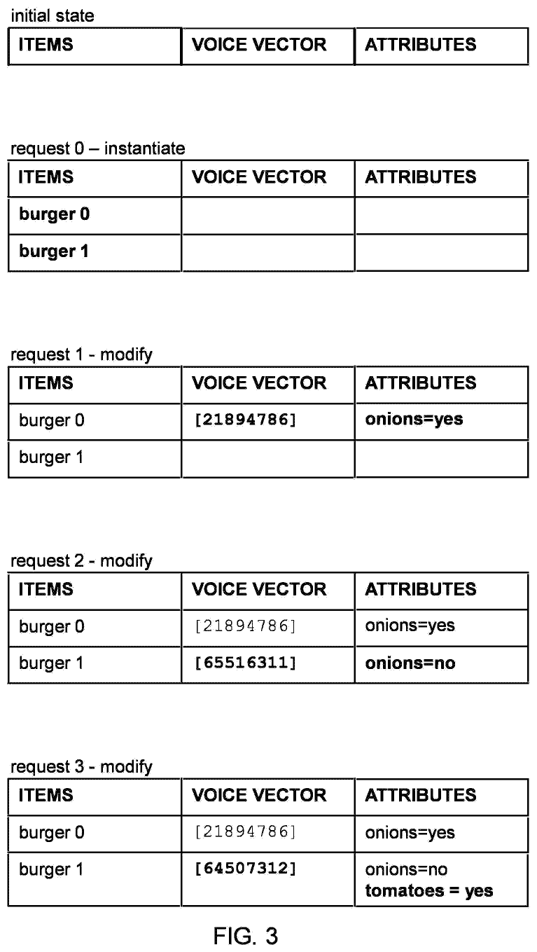

FIG. 3 shows a data structure and changes to it as the requests are processed. Each request is matched to a pattern. Some implementations support simple, easy to define patterns such as specific sequences of words and a corresponding function to perform. Some implementations support patterns with slots such that the pattern can match word sequences with any, or a specific set, of words in the slot location within the pattern. Some implementations support patterns with complex regular expressions. Some implementations support programmable functions that can match recognized word sequences. Some implementations consider an ASR score for each word, or the full word sequence, recognized from an audio segment.

In the example scenario, the voice interface is programmed with patterns needed to recognize restaurant orders for burgers. When a session begins, the interface creates a data structure that has an empty list of items and the capability to store, for each instance of an item, a voice vector and a list of attribute values of the item instance.

Request 0 has recognized text “we want two burgers”. The words are matched to a pattern that recognizes the words “want” and “burger” with an optional slot for a number of instances, which it fills with the number 2. In response to understanding the word sequence, the voice interface adds two burger instances to the order data structure.

Request 1 has voice vector 21894786 and recognized text “put onions on my burger”. The words are matched to a pattern that has a slot for a list of known burger attributes. One such attribute is onions that can have a Boolean value for “yes” or “no”. The words “on my burger” following the word “onions” causes the voice interface to add the attribute onions to the data structure in relation to the instance burger 0 and assign the attribute onions the value “yes”. The interface stores the voice vector 21894786 in relation to burger 0.

Request 2 has voice vector 65516311 and recognized text “no onions on my burger”. The words are matched to a pattern that has the word “no” followed by a slot for a list of known burger attributes, including onions as with the request 1.

The interface searches through the list of burgers for an instance having an associated voice vector with a cosine distance within a threshold distance of the voice vector of request 2. The interface only has one burger with a voice vector, which is 21894786. That is a large cosine distance in the voice vector space from the voice vector of request 2. Therefore, the voice interface infers that request 2 corresponds to a different burger than any one in the list. Because the voice vector of request 2 is greater than a threshold distance from the voice vector associated with any item in the list, the voice interface can also infer that the voice of request 2 is from a different user than any who has spoken previously in the ordering session.

Because the match of the words of request 2 to the pattern causes the voice interface to add the attribute onions to the data structure in relation to a burger, and no voice vector is yet associated with burger 1, the voice interface assigns the attribute onions the value “no in relation to burger 1”. The voice interface also stores the voice vector 65516311 from request 2 in relation to burger 1.

Request 3 has voice vector 64507312 and recognized text “I do want tomatoes”. The words are matched to a pattern that has the word “want” followed by a slot for a list of known burger attributes, including tomatoes as an attribute.

The interface searches through the list of burgers for an instance having an associated voice vector with a cosine distance within a threshold distance of the voice vector of request 3. The interface has two burgers. The voice vector 65516311 is stored in relation to burger 1. The cosine distance between the voice vector of burger 1 and the voice vector of request 3 is within a threshold. Therefore, the voice interface infers that request 3 is from the same person who made the request related to burger 1. Therefore, the voice interface adds the attribute tomatoes with burger 1 and assigns it the value “yes”.

Though, due to random variations and differences of phonemes analyzed between request segments, it is rare that two segments would have exactly the same voice vector calculation, by recognizing that a request has a voice vector close to one stored in relation to a burger instance, the voice interface is able to, in effect, configure the attributes of the same burger specifically as requested in different requests by the same speaker. Conversely, by recognizing large distances between voice vectors, the voice interface is able to customize the attributes of burgers separately for different users.

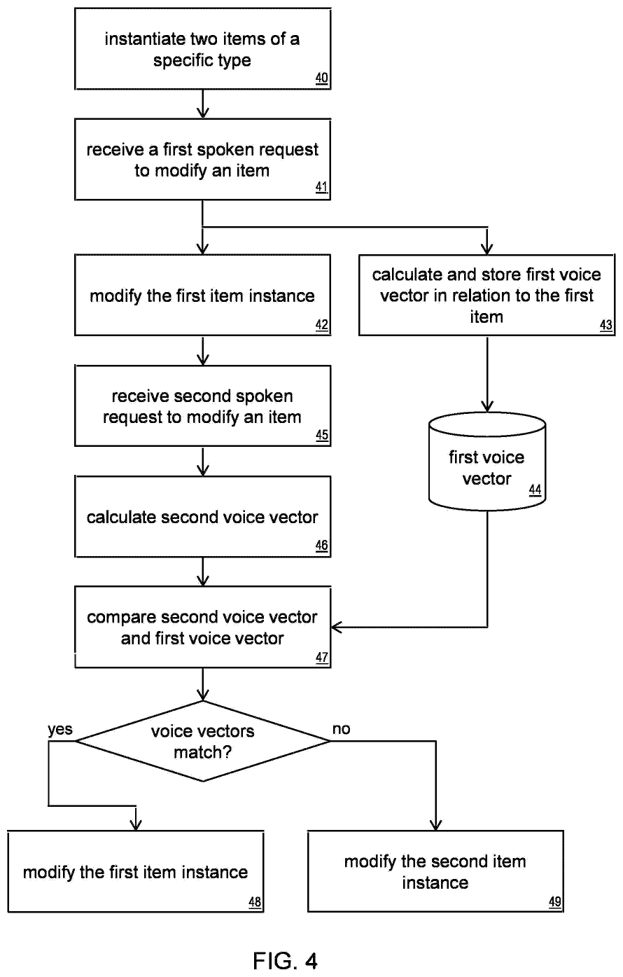

FIG. 4 shows a flowchart of a method of recognizing multi-participant voice orders. The method begins when a voice ordering session begins and instantiates two items of a specific type 40. In the next step, the method receives a first spoken request to modify an item 41. In response, the method modifies the first item instance 42. It also calculates and stores a first voice vector in relation to the first item 43. The first voice vector is stored in a computer memory 44. Next, the method receives a second spoken request to modify an item 45. The method then calculates a second voice vector 46. It proceeds to compare the second voice vector to the first voice vector 47. If the voice vectors match, by being within a threshold distance of each other, the method proceeds to modify the first item instance 48. If the voice vectors do not match, the method proceeds to modify the second item instance.

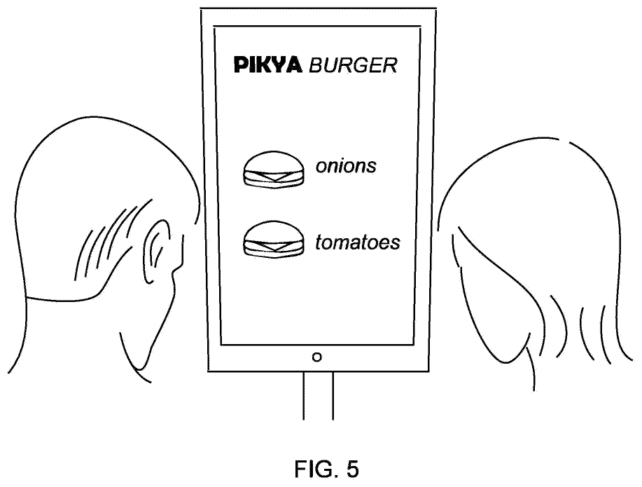

FIG. 5 shows two people with different voices using a kiosk with a voice interface to order two burgers, one having onions and the other having tomatoes. The kiosk is a device that implements the method described in FIG. 4 to carry out the example scenario described with respect to FIG. 2 and FIG. 3. The burger kiosk implements the methods by running software stored in a memory device with a computer processor in a system-on-chip.

### Device Implementations

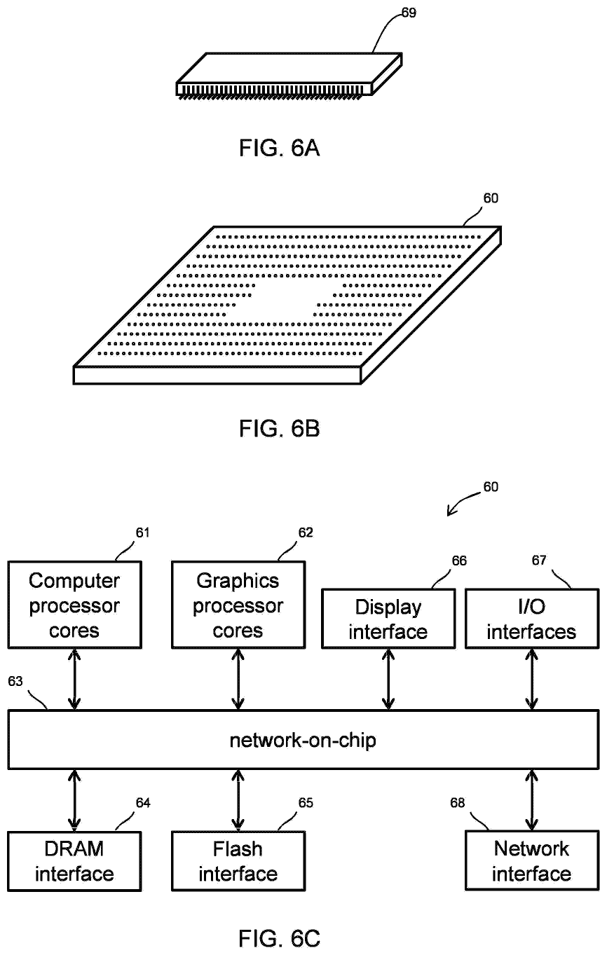

FIG. 6A shows a Flash memory chip 69. It is an example of a non-transitory computer readable medium that can store code that, if executed by a computer processor, would cause the computer processor to perform methods of multi-participant voice ordering. FIG. 6B shows a system-on-chip 60. It is packaged in a ball grid array package for surface mounting to a printed circuit board.

FIG. 6C shows a functional diagram of the system-on-chip 60. It comprises an array of multiple computer processor cores (CPU) 61 and graphic processor cores (GPU) 62 connected by a network-on-chip 63 to a dynamic random access memory (DRAM) interface 64 for storing information such as item attribute values and voice vectors and a Flash memory interface 65 for storing and reading software instructions for the CPUs and GPUs. The network-on-chip also connects the functional blocks to a display interface 66 that can output, for example, the display for a voice ordering kiosk. The network-on-chip also connects the functional blocks to an I/O interface 67 for connection to microphones and other types of devices for interaction with users such as speakers, touch screens, cameras, and haptic vibrators. The network-on-chip also connects the functional blocks to a network interface 68 that allows the processors and their software to perform API calls to cloud servers or other connected devices.

### SUMMARY

A system is provided that recognizes spoken commands, queries, or other types of utterance from multiple users and identifies the user who spoke an utterance by features of their voices. The system then modifies one of multiple instances of a type of item where the instance modified corresponds to which user is identified. The system includes speech recognition that is configured to transcribe spoken commands. The system also includes voice discrimination that characterizes the voices of utterances and can identify the user, from among several others, based on their voices' characteristics.

In one embodiment, the system is configured to display the modified instances of the items on a display device, such as a computer screen or a mobile device. The system may also be configured to generate audio or visual output corresponding to the modified instances of the items, such as a synthesized voice speaking the name of the item or a visual representation of the item.

In another embodiment, the system is configured to receive input from a user, such as a voice command or a touch gesture, that indicates a preference for a specific instance of the item. The system may then select the specified instance of the item and modify it according to the voice characteristics of the spoken command for the identified user.

The system may also be configured to learn from past usage and adjust the selection and modification of items based on the preferences of the individual users or the context of the spoken command. For example, if one user frequently selects a certain instance of an item, the system may automatically select that instance in future instances of the spoken command for that user.

In yet another embodiment, the system may be configured to incorporate additional information, such as context or personal preferences, into the selection and modification of items for each user. For example, the system may consider the location of the users or the time of day when selecting and modifying instances of items for each user.

The system provides a convenient and intuitive way to interact with spoken commands and modify instances of items based on the characteristics of the speaker's voice, allowing for personalized experiences for multiple users. The system may be implemented in a variety of settings, such as in educational or entertainment applications, or in voice-controlled personal assistants.

1. A computer-implemented method comprising:
receiving a first spoken utterance that specifies a type of item to modify;
calculating a first voice feature vector from the first spoken utterance;
in response to the first spoken utterance, modifying a first item of the specified type;
storing the first voice feature vector in relation to the first item;
receiving a second spoken utterance to modify an item of the specified type;
calculating a second voice feature vector from the second spoken utterance;
in response to determining that the second voice feature vector and the first voice feature vector have a difference greater than a threshold, modifying a second item of the specified type; and
outputting an indication of the status of the modified first item and the status of the modified second item.

2. The method of claim 1, wherein voice feature vectors are calculated by:
identifying a start of voice activity in audio;
performing automatic speech recognition on the audio to recognize words;
detecting the completion of the utterance by matching the recognized words to a word pattern; and
computing the voice feature vector as a vector of aggregate voice features in the audio between the start of voice activity and the completion of the utterance.

3. The method of claim 1, wherein modifying the second item is in response to the second spoken utterance being received within a period of time of receiving the first spoken utterance, the period of time being less than thirty seconds.

4. The method of claim 1, wherein the first item and the second item are members of a list.

5. The method of claim 1, wherein determining that the second voice feature vector and the first voice feature vector have a difference greater than a threshold comprises:
computing a distance between points represented by the vectors in a multidimensional space; and
determining that the second voice feature and the first voice feature vector have a distance in the vector space greater than a threshold.

6. A computer-implemented method comprising:
receiving a first spoken utterance that specifies a type of item to order or modify;
calculating a first voice feature signature from the first spoken utterance;
in response to the first spoken utterance, ordering or modifying a first item of the specified type;
storing the first voice feature signature in relation to the first item;
receiving a second spoken utterance to order or modify an item of the specified type;
calculating a second voice feature signature from the second spoken utterance; and
in response to determining that the second voice feature signature and the first voice feature signature have a difference greater than a threshold, ordering or modifying a second item of the specified type.

7. The method of claim 6, further comprising the step of outputting an indication of the status of the modified first item and the status of the modified second item.

8. The method claim 6, wherein said step of calculating a first voice feature signature from the first spoken utterance comprises the step of calculating a first voice feature vector from the spoken utterance, and wherein the step of calculating a second voice feature signature from the second spoken utterance comprises the step of calculating a second voice feature vector from the second spoken utterance.

9. The method of claim 8, wherein voice feature vectors are calculated by:
identifying a start of voice activity in audio;
performing automatic speech recognition on the audio to recognize words;
detecting the completion of the utterance by matching the recognized words to a word pattern; and
computing the voice feature vector as a vector of aggregate voice features in the audio between the start of voice activity and the completion of the utterance.

10. The method of claim 8, wherein determining that the second voice feature vector and the first voice feature vector have a difference greater than a threshold comprises:
computing a distance between points represented by the vectors in a multidimensional space; and
determining that the second voice feature and the first voice feature vector have a distance in the vector space greater than a threshold.

11. The method of claim 6, wherein modifying the second item is in response to the second spoken utterance being received within a period of time of receiving the first spoken utterance, the period of time being less than thirty seconds.

12. The method of claim 6, wherein the first item and the second item are members of a list.

13. A computer-implemented method comprising:
calculating a first voice feature signature from a received first spoken utterance that specifies a first item of a specified type to order or modify;
storing the first voice feature signature in relation to the first item;
calculating a second voice feature signature from a received second spoken utterance to order or modify an item of the specified type; and
in response to determining that the second voice feature signature and the first voice feature signature have a difference greater than a threshold, ordering or modifying a second item of the specified type.

14. The method of claim 13, further comprising the step of outputting an indication of the status of the modified first item and the status of the modified second item.

15. The method claim 13, wherein said step of calculating a first voice feature signature from the first spoken utterance comprises the step of calculating a first voice feature vector from the spoken utterance, and wherein the step of calculating a second voice feature signature from the second spoken utterance comprises the step of calculating a second voice feature vector from the second spoken utterance.

16. The method of claim 15, wherein voice feature vectors are calculated by:
identifying a start of voice activity in audio;
performing automatic speech recognition on the audio to recognize words;
detecting the completion of the utterance by matching the recognized words to a word pattern; and
computing the voice feature vector as a vector of aggregate voice features in the audio between the start of voice activity and the completion of the utterance.

17. The method of claim 15, wherein determining that the second voice feature vector and the first voice feature vector have a difference greater than a threshold comprises:
computing a distance between points represented by the vectors in a multidimensional space; and
determining that the second voice feature and the first voice feature vector have a distance in the vector space greater than a threshold.

18. The method of claim 13, wherein modifying the second item is in response to the second spoken utterance being received within a period of time of receiving the first spoken utterance, the period of time being less than thirty seconds.

19. The method of claim 13 wherein the first item and the second item are members of a list.
